(19) United States
(12) Patent Application Publication
(10) Pub. No.: US 2026/0072377 A1
(43) Pub. Date: Mar. 12, 2026

(54) TONER CARTRIDGE AND IMAGE FORMING APPARATUS

(71) Applicant: CANON KABUSHIKI KAISHA, Tokyo (JP)

(72) Inventor: HIROKI OGINO, Shizuoka (JP)

(21) Appl. No.: 19/323,013

(22) Filed: Sep. 9, 2025

(30) Foreign Application Priority Data
Sep. 12, 2024 (JP) 2024-158650

(51) Int. Cl. G03G 15/08; G03G 21/16; G03G 21/18; G03G 21/20

(52) U.S. Cl. CPC G03G 15/0879; G03G 15/0881; G03G 21/1647; G03G 21/1814; G03G 21/206; G03G 2221/163

(57) ABSTRACT

A toner cartridge includes a frame, a ventilation partitioning the space into an accommodating chamber and an air chamber, a pump, a tube, a coupling member; and a seal sealing a gap between an outer peripheral surface of the coupling member and the frame. The seal includes a contacting portion contactable with the coupling member on an inner peripheral side and a supporting portion supporting the contacting portion on an outer peripheral side. When a position of the contacting portion is a first position in a state where the frame and the tube are not coupled, the position of the contacting portion is changed to a second position by the seal being elastically deformed in a state where the frame and the tube are coupled. When a side from which the air flows is an upstream side, the second position is in a downstream side of the supporting portion.

### BACKGROUND

### Field of the Technology

The present invention relates to a toner cartridge and an image forming apparatus and, for example, to the toner cartridge for an electrophotographic image forming apparatus and the image forming apparatus which uses these toner cartridges.

### Description of the Related Art

In an electrophotographic image forming apparatus, a configuration in which a toner cartridge accommodating toner which is used for image formation and/or a process cartridge for performing an electrophotographic process is configured to be mountable to and demountable from a main assembly of the image forming apparatus is widely known. Among these toner cartridges, there is a configuration, for example, as in Japanese Patent Application Laid-Open No. 2000-147884, in which air is flown into a toner accommodating portion and the toner is discharged and transported by air pressure.

### SUMMARY

In order to solve the aforementioned problems, the present invention includes the following configuration.
(1) A toner cartridge comprising: a frame configured to form a space inside thereof; a ventilation member fixed to the frame and configured to partition the space into an accommodating chamber for accommodating toner and an air chamber including a receiving opening for receiving air, the ventilation member restricting passing of the toner and allowing passing of the air; a pump configured to discharge the air to be supplied to the air chamber; a tube configured to transport the air from the pump to the receiving opening of the frame; a cylindrical coupling member including a passage for communicating the air between the frame and the tube, the coupling member being configured to couple the frame and the tube; and an annular seal portion configured to seal a gap between an outer peripheral surface of the coupling member and the frame, wherein the seal portion includes a contacting portion configured to be contactable with the outer peripheral surface of the coupling member on an inner peripheral side thereof and a supporting portion supporting the contacting portion on an outer peripheral side thereof, wherein when a position of the contacting portion of the seal portion is defined as a first position in a state in which the frame and the tube are not coupled, the position of the contacting portion is changed to a second position by the seal portion being elastically deformed in a state in which the frame and the tube are coupled, and wherein when a side from which the air flows in a direction of the passage of the coupling member is defined as an upstream side, the second position is positioned in a downstream side of the supporting portion.
(2) A toner cartridge comprising: a frame configured to form a space inside thereof; a ventilation member fixed to the frame and configured to partition the space into an accommodating chamber for accommodating toner and an air chamber including a receiving opening for receiving air, the ventilation member restricting passing of the toner and allowing passing of the air; a pump configured to discharge the air to be supplied to the air chamber; a tube configured to transport the air from the pump to the receiving opening of the frame; a cylindrical coupling member including a passage for communicating the air between the frame and the pump, the coupling member being configured to couple the frame and the tube; and an annular seal member configured to seal a gap between an outer peripheral surface of the coupling member and the frame, wherein when a side from which the air flows in a direction of the passage of the coupling member is defined as an upstream side, the coupling member includes a first portion of which an outer diameter is the same and a second portion of which an outer diameter becomes smaller from the first portion toward the upstream side.
(3) An image forming apparatus comprising: a main assembly of the image forming apparatus configured to detachably support a toner cartridge, wherein the toner cartridge including: a frame configured to form a space inside thereof; a ventilation member fixed to the frame and configured to partition the space into an accommodating chamber for accommodating toner and an air chamber including a receiving opening for receiving air, the ventilation member restricting passing of the toner and allowing passing of the air; a pump configured to discharge the air to be supplied to the air chamber; a tube configured to transport the air from the pump to the receiving opening of the frame; a cylindrical coupling member including a passage for communicating the air between the frame and the tube, the coupling member being configured to couple the frame and the tube; and an annular seal portion configured to seal a gap between an outer peripheral surface of the coupling member and the frame, wherein the seal portion includes a contacting portion configured to be contactable with the outer peripheral surface of the coupling member on an inner peripheral side thereof and a supporting portion supporting the contacting portion on an outer peripheral side thereof, wherein when a position of the contacting portion of the seal portion is defined as a first position in a state in which the frame and the tube are not coupled, the position of the contacting portion is changed to a second position by the seal portion being elastically deformed in a state in which the frame and the tube are coupled, wherein when a side from which the air flows in a direction of the passage of the coupling member is defined as an upstream side, the second position is positioned in a downstream side of the supporting portion, wherein the coupling member includes a first portion of which an outer diameter is the same and a second portion of which an outer diameter becomes smaller from the first portion toward the upstream side. and wherein the toner cartridge is supplied with the air by the pump while the coupling member is coupled with the receiving opening.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus in an Embodiment 1

FIG. 2, part (a) and part (b), includes a cross-sectional view of a process cartridge and a cross-sectional view of a toner cartridge in the Embodiment 1.

FIG. 3, part (a), part (b) and part (c), includes cross-sectional views describing a coupling structure between an air inlet opening and a coupling portion in the Embodiment 1.

FIG. 4 is a schematic view illustrating a toner supplying state to the process cartridge in the Embodiment 1.

FIG. 5, part (a), part (b) and part (c), includes a detailed cross-sectional view and a perspective view of the toner cartridge in the Embodiment 1.

FIG. 6, part (a) and part (b), includes a detailed cross-sectional view and a perspective view of a toner cartridge in an Embodiment 2.

FIG. 7, part (a), part (b) and part (c), includes cross-sectional views describing a coupling structure between an air inlet opening and a coupling portion in the Embodiment 2.

FIG. 8, part (a) and part (b), includes a detailed cross-sectional view and a perspective view of a toner cartridge in an Embodiment 3.

FIG. 9, part (a), part (b) and part (c), includes cross-sectional views describing a coupling structure between an air inlet opening and a coupling portion in the Embodiment 3.

FIG. 10, part (a) and part (b), includes a detailed cross-sectional view and a perspective view of a toner cartridge in an Embodiment 4.

FIG. 11, part (a), part (b) and part (c), includes cross-sectional views describing a coupling structure between an air inlet opening and a coupling portion in the Embodiment 4.

FIG. 12, part (a) and part (b), includes a cross-sectional view and a perspective view of a modified example of a seal portion as an Embodiment 5.

FIG. 13 is a cross-sectional view of a modified example of a toner cartridge as an Embodiment 6.

FIG. 14, part (a) and part (b), includes cross-sectional views of a modified example of a mounting method of a toner cartridge as an Embodiment 7.

FIG. 15 is a cross-sectional view of a modified example of a toner cartridge as an Embodiment 8.

FIG. 16, part (a) and part (b), includes cross-sectional views and perspective views of modified examples of a guide portion as an Embodiment 9.

### DESCRIPTION OF THE EMBODIMENTS

Hereinafter, exemplary modes for implementing the present invention will be described with reference to the drawings. Examples of an image forming apparatus in the description below include a copy machine, a printer, a multifunction machine, a commercial printing device, etc. The image forming apparatus forms an image on a recording medium based on image information input from an external computer and/or image information read from an original. For the recording medium, sheet material of various material and shapes such as, a paper such as a plain paper and a thick paper, a plastic film, a coated paper, a sheet having a special shape such as an envelope and an index paper, and cloth is used.

### Embodiment 1

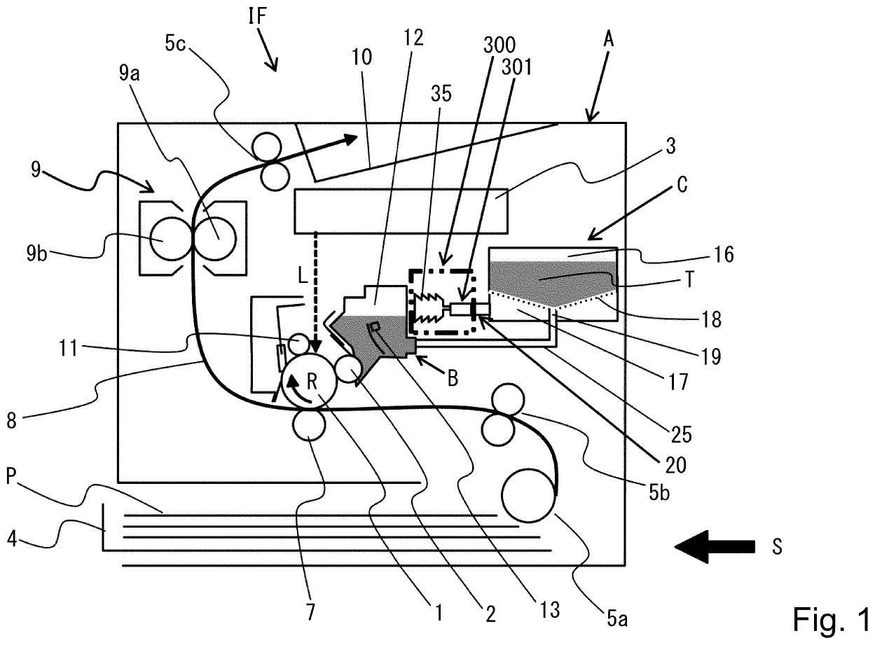

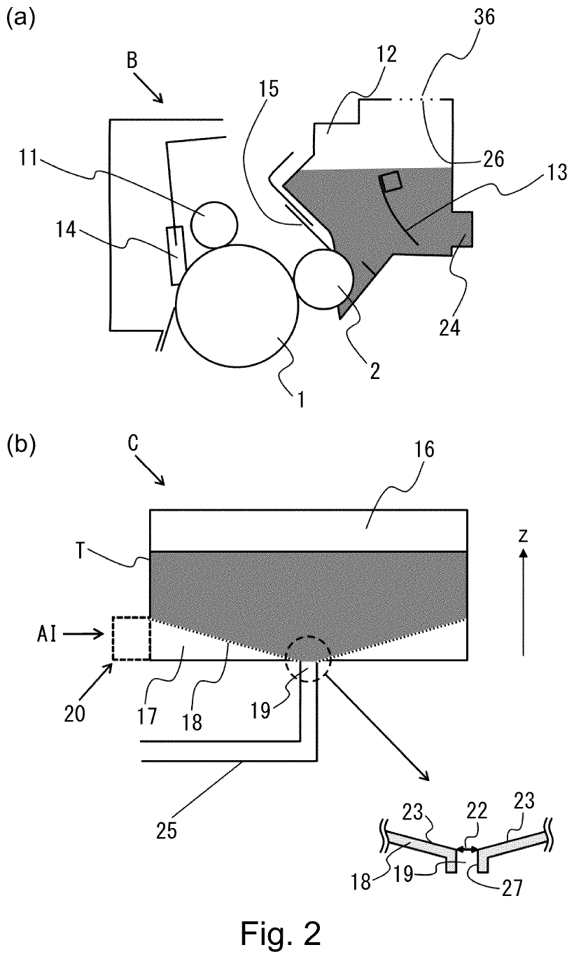

FIG. 1 is an outline view illustrating a cross-sectional structure of an image forming apparatus IF in an Embodiment 1, part (a) of FIG. 2 is a cross-sectional outline view of a process cartridge B, and part (b) of FIG. 2 is a cross-sectional outline view of a toner cartridge C. As shown in FIG. 1, the process cartridge B and the toner cartridge C are mounted to a main assembly A of the image forming apparatus IF, and form an image on a sheet P as a recording medium. The main assembly A is a portion of the image forming apparatus IF minus the process cartridge B and the toner cartridge C.

### <Overall Configuration of the Image Forming Apparatus>

As shown in FIG. 1, the image forming apparatus IF in the Embodiment 1 forms an electrostatic latent image on a surface of a photosensitive drum 1 using a laser beam emitted from a laser scanner 3 as an exposure means. The image forming apparatus IF is a laser beam printer of an electrophotographic type, which transfers an image developed by using toner T as developer (developer image, toner image) to the sheet P. To the main assembly A, in addition to the process cartridge B and the toner cartridge C, along with a direction in which the sheet P is conveyed from a sheet tray 4 (hereinafter, referred to as a conveyance direction), a pickup roller 5a, a conveyance roller pair 5b, a transfer roller 7, a fixing device 9, a discharging roller pair 5c and a discharge tray 10 are provided.

The process cartridge B includes the photosensitive drum 1, a developing roller 2 as a developer carrying member, a charging roller 11 as a charging means, a toner chamber 12 which accommodates the toner T to be supplied to the developing roller 2, etc. The toner cartridge C accommodates the toner T to be replenished to the toner chamber 12 of the process cartridge B. The charging roller 11 which performs a charging process, the developing roller 2 which performs a developing process, and the transfer roller 7 which performs a transfer process are all examples of a process means which acts on the photosensitive drum 1 as a photosensitive member in an electrophotographic process.

### <Image Forming Process>

When the image forming apparatus IF receives a signal to start an image formation to the sheet P, the photosensitive drum 1 is rotationally driven in a direction of an arrow R. The charging roller 11 contacts an outer peripheral surface of the photosensitive drum 1 and uniformly and evenly charges the surface of the photosensitive drum 1 (on the photosensitive drum). The laser scanner 3 irradiates the photosensitive drum 1 with a laser beam L based on the image information, and writes the electrostatic latent image on the surface of the photosensitive drum 1.

The toner T accommodated in the toner chamber 12 is send out toward the developing roller 2 by a stirring member 13, and is carried on a surface of the developing roller 2. The toner T, which reaches a developing area where the developing roller 2 and the photosensitive drum 1 are opposing to each other, is transferred from the developing roller 2 to the surface of the photosensitive drum 1 according to a potential distribution on the surface of the photosensitive drum 1. As a result, the electrostatic latent image on the surface of photosensitive drum 1 is visualized as a toner image.

In parallel with these processes, feeding of the sheet P is performed at a timing in synchronization with the exposing operation by the laser scanner 3. The pickup roller 5a shown in FIG. 1 sends out the sheet P, which is stacked on the sheet tray 4, from the sheet tray 4. The conveyance roller pair 5b receives the sheet P from the pickup roller 5a, and conveys the sheet P to a transfer portion between the photosensitive drum 1 and the transfer roller 7. And by a transfer voltage being applied to the transfer roller 7, the toner image carried on the photosensitive drum 1 is transferred to the sheet P.

The sheet P, on which the toner image has been transferred, is conveyed along a conveyance guide 8 to the fixing device 9. The fixing device 9 applies heat and pressure to the toner image on the sheet P with a heating roller 9a and a pressing roller 9b, and fixes the toner image to the sheet P. The sheet P, which has been subjected to the fixing process for the image, is discharged by the discharging roller pair 5c to the discharge tray 10, which is provided to an upper portion of the main assembly A.

### <Configuration of the Process Cartridge>

Next, using part (a) of FIG. 2, an outline configuration of the process cartridge B will be described. The process cartridge is a cartridge provided with the image bearing member and the process means which acts to the image bearing member. Here, the process means include, for example, the charging means which charges the surface of the image bearing member, the developing device which forms the image on the image bearing member, and a cleaning means for removing the toner remaining on the surface of the image bearing member.

The process cartridge B in the Embodiment 1 is configured to be mountable to and demountable from the main assembly A. And, around the photosensitive drum 1 as the image bearing member, the charging roller 11 as the charging means and a cleaning blade 14 as the cleaning means is provided. In addition, as the developing device, the developing roller 2, a developing blade 15 and the toner chamber 12, which accommodates the toner to be supplied to the developing roller 2, are provided to the process cartridge B. In addition, to the process cartridge B, a receiving opening 24, which receives the toner replenished from the toner cartridge C, and an exhaust portion 26 which allows air in the toner chamber 12 to pass are provided on an upper surface of the toner chamber 12, and a filter 36 as a ventilation portion is provided on an upper surface of the exhaust portion 26.

### <Configuration of the Toner Cartridge>

Next, using part (b) of FIG. 2, an outline configuration of the toner cartridge C will be described. Part (b) of FIG. 2 is a cross-sectional view of the toner cartridge C, to which the present invention can be applied. In lower right of part (b) of FIG. 2, an enlarged view of a main portion of a discharging opening 19 (inside a broken line circle), which will be described below, is also illustrated. An arrow in part (b) of FIG. 2 indicates a vertical direction, and hereinafter the direction is referred to as a z direction. The toner cartridge C accommodates the toner T to be replenished to the process cartridge B. The toner cartridge C in the Embodiment 1 is provided with a toner accommodating portion 16, an air chamber 17, a ventilation member 18, the discharging opening 19 and an air inlet opening 20. The ventilation member 18 is disposed below the toner accommodating portion 16 in the vertical direction, and the air inlet opening 20 is disposed outside the air chamber 17.

The toner accommodating portion 16 accommodates the toner. The air chamber 17 is partitioned from the toner accommodating portion 16 by the ventilation member 18. The ventilation member 18 does not allow the toner to pass but allows air to pass. The ventilation member 18 is fixed to a frame of the toner cartridge C, which forms a space inside the toner cartridge C. The ventilation member 18 is a member which is partitioning the space into the toner accommodating portion 16 as an accommodating chamber which accommodates the toner and the air chamber 17 including the receiving opening which receives air, restricts the passing of the toner, and allows the passing of air. In the z direction, the ventilation member 18 includes an inclined portion 23 of which a lowest point corresponds the discharging opening 19, and the inclined portion 23 forms a bottom surface of the toner accommodating portion 16. The air inlet opening 20 is provided in the air chamber 17, and is an inlet opening for receiving air supplied from an air supplying portion 300, which will be described below. The discharging opening 19 is connected to a transport path 25 through which the toner T is transported to the toner chamber 12 of the process cartridge B.

In the configuration in the Embodiment 1, an opening portion 22 (a portion indicated by a bidirectional arrow), which is an entrance of the discharging opening 19, is formed as a through hole which is opened in the ventilation member 18. The discharging opening 19 is constituted by a cylindrical shape formed by a side surface portion 27 of the ventilation member 18. The ventilation member 18 is a porous member made of resin fibers, for example, and the pores have sizes and density which allows the air to pass but does not allow the toner to pass. In addition, for the ventilation member 18, filter material formed by a heat pressing, etc., for example, may be used.

### <Configuration of the Air Supplying Portion>

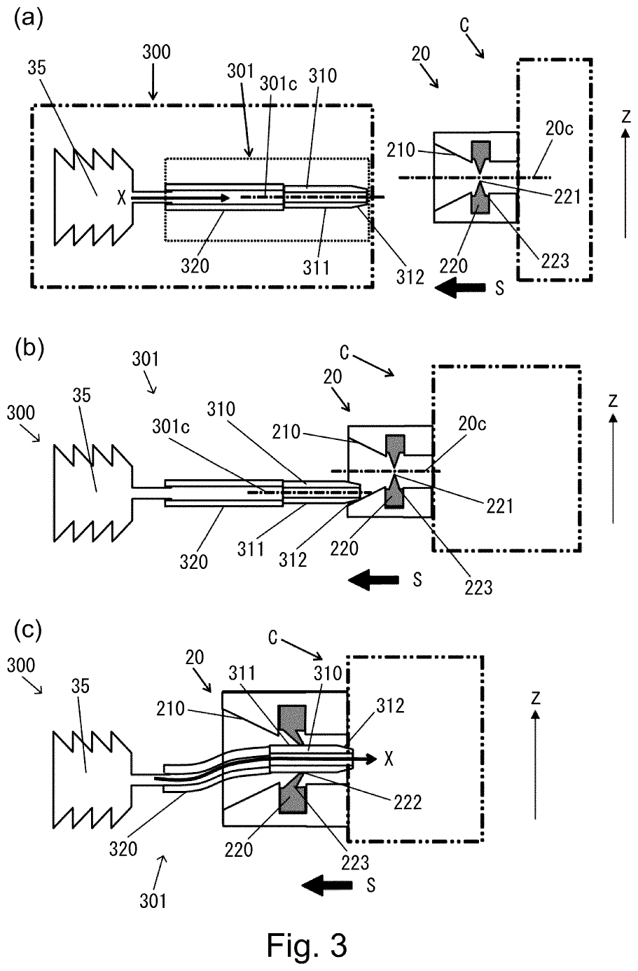

Next, using FIG. 3, an outline configuration of the air supplying portion 300 as an air supplying means will be described. FIG. 3 includes cross-sectional views which describes a coupling structure between the air inlet opening 20 and a coupling portion 301, to which the present invention can be applied. The air supplying portion 300 includes a coupling member 310, and supplies air to the air chamber 17. The coupling member 310 is a cylindrical member including a passage for communicating the air between the frame of the toner cartridge C and a tube, which will be described below, and couples the frame of the toner cartridge C and the tube.

As shown in part (a) of FIG. 3, the air supplying portion 300 is provided with a pump 35 and the coupling portion 301 for supplying air to the air chamber 17 of the toner cartridge C. Details of the coupling portion 301 will be described below. The pump 35 is a reciprocating pump having a bellows shape, and is reciprocally driven by an unshown motor, a gear and a cam. The pump 35 discharges air to be supplied to the air chamber 17. Incidentally, the air supplying portion 300 in the Embodiment 1 is provided to the main assembly A, however, may be configured as being provided to the process cartridge B. In addition, for the pump 35, instead of the reciprocating pump, a diaphragm pump or a rotary pump may be used.

### <Mechanism of Toner Discharging>

Next, a mechanism by which the toner T is discharged from the toner cartridge C will be described using FIG. 1 and part (b) of FIG. 2. When the toner cartridge C is mounted to the main assembly A, as shown in FIG. 1, the coupling portion 301 of the air supplying portion 300 and the air inlet opening 20 of the toner cartridge C are coupled. Details of the coupling structure between the coupling portion 301 and the air inlet opening 20 will be described below. The air discharged by the pump 35 of the air supplying portion 300 passes, as shown by an arrow AI in part (b) of FIG. 2, from the air chamber 17 of the toner cartridge C through the ventilation member 18, and is flown into the toner accommodating portion 16. The air which has been flown into the toner accommodating portion 16 is, while fluidizing the toner T in the toner accommodating portion 16, discharged with the toner T from the discharging opening 19.

### <Toner Transport to the Process Cartridge>

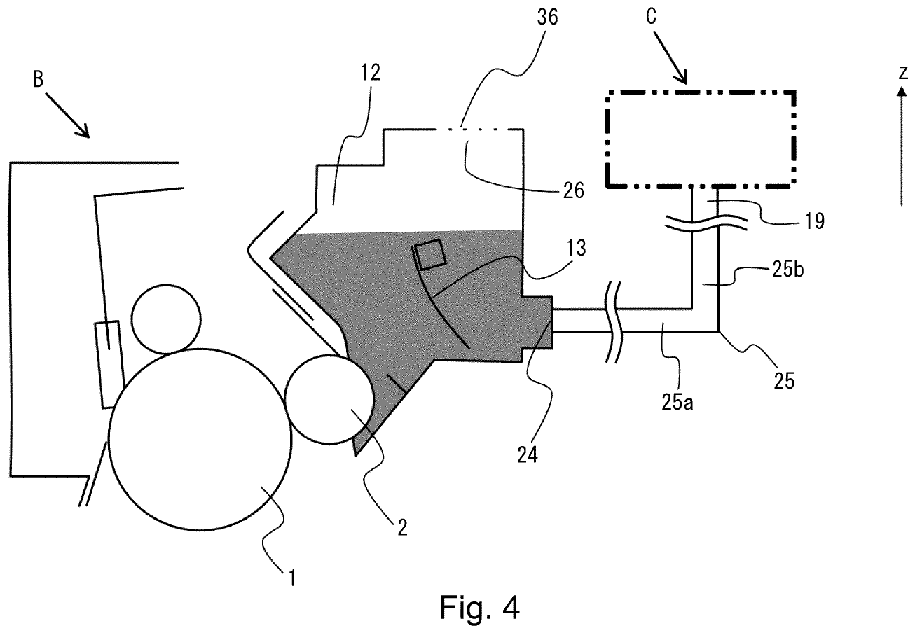

Next, transport of the toner T, which has been discharged from the toner cartridge C, to the process cartridge B will be described using FIG. 4. The toner chamber 12 of the process cartridge B includes the receiving opening 24 for receiving the toner T from the toner cartridge C. The discharging opening 19 and the receiving opening 24 are connected by the transport path 25. The transport path 25 in the Embodiment 1 is structured as a part of the process cartridge B, and includes a horizontal transport path 25a connected to the receiving opening 24 and a vertical transport path 25b connected to the discharging opening 19. The horizontal transport path 25a is perpendicular to the z direction, and the vertical transport path 25b is parallel to the z direction. The discharging opening 19 and the vertical transport path 25b are connected to and disconnected from each other via an unshown connecting structure as the toner cartridge C is attached and detached.

The toner T, which has been discharged from the toner cartridge C by an action of the air, is flown with the air into the toner chamber 12 of the process cartridge B via the transport path 25. And the air, which has been flown into the toner chamber 12, passes through the exhaust portion 26, which is provided to the upper surface of the toner chamber 12, passes through the filter 36 which the toner does not pass through, and is exhausted out of the process cartridge B.

A cross-sectional area of the filter 36 provided to the process cartridge B is arranged so as to be larger than a cross-sectional area of the discharging opening 19 of the toner cartridge C. By this, it becomes possible to make a flowing speed of the air which is flown in with the toner T from the toner cartridge C slower when passing through the filter 36 than when passing through the discharging opening 19. Therefore, upon the air being discharged outside through the filter 36, it becomes possible to suppress the toner T from being blown up in the process cartridge B due to the air discharged outside.

As a result, it becomes possible to suppress that the toner T is adhered to the filter 36, and suppress reduction of permeability of the air through the filter 36. Therefore, it becomes possible to reliably exhaust the air, which has been flown into the toner chamber 12, and suppress that the transport of the toner T from the toner cartridge C to the process cartridge B is prevented.

### <Detailed Configuration of the Air Inlet Opening 20 of the Toner Cartridge C>

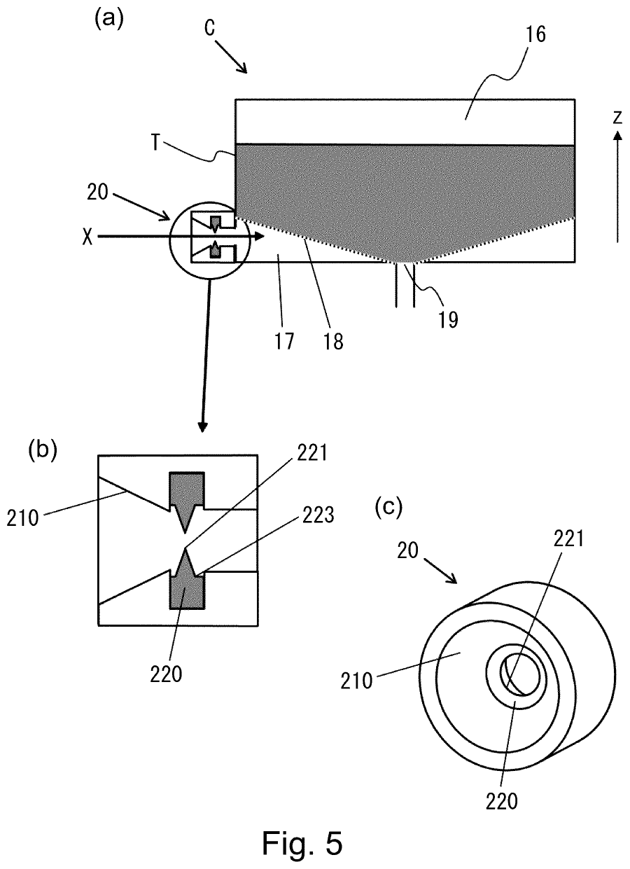

Using FIG. 5, a configuration of the air inlet opening 20 of the toner cartridge C, which is a characteristic configuration in the Embodiment 1, will be described. Part (a) of FIG. 5 is a cross-sectional view illustrating the configuration of the air inlet opening 20 of the toner cartridge C, to which the present invention can be applied, part (b) of FIG. 5 is an enlarged cross-sectional view of the air inlet opening 20, and part (c) of FIG. 5 is a perspective view of the air inlet opening 20.

As shown in FIG. 5, the air inlet opening 20 provided to the air chamber 17 is constituted by a guide portion 210 and a seal portion 220, and as shown in part (c) of FIG. 5, the guide portion 210 is structured approximately as a mortar shape. In other words, the guide portion 210 has a truncated cone shape (funnel shape), and is configured so that an upper surface of the truncated cone is disposed closer to the air chamber 17 and a bottom surface of the truncated cone is disposed away from the air chamber 17. The guide portion 210 guides the coupling member 310 to the seal portion 220. The guide portion 210 increases in an inner diameter thereof toward the coupling member 310.

The seal portion 220 is an annular portion which seals a gap between an outer peripheral surface of the coupling member 310 and the frame of the toner cartridge C. The seal portion 220 is elastically deformed by and is in contact with the coupling portion 301 of the air supplying portion 300, which will be described below, and includes an acting portion 221 as the smallest diameter of the seal portion 220 and a supporting portion 223 which supports the elastic deformation of the seal portion 220. The acting portion 221 as a contacting portion is configured to be contactable with the outer peripheral surface of the coupling member 310 on an inner peripheral side of the seal portion 220, and the supporting portion 223 supports the acting portion 221 on an outer peripheral side thereof. The seal portion 220 has an annular shape, and the acting portion 221 of the seal portion 220 is structured as an approximately circular shape (part (c) of FIG. 5). The acting portion 221 is a smallest diameter (inner diameter) portion of the annular. The acting portion 221 is a contacting portion which contacts the coupling member 310 upon the coupling member 310 being coupled to the air inlet opening 20. The supporting portion 223 supports the acting portion 221 when the acting portion 221, which has contacted the coupling member 310, is elastically deformed. Incidentally, for the seal portion 220, it may be a configuration in which an elastic member such as a common rubber material, elastomer and silicone or a known oil seal is used.

### <Detailed Configuration of the Coupling Portion 301 of the Air Supplying Portion 300>

Using FIG. 3, a configuration of the coupling portion 301 of the air supplying portion 300, which is a characteristic configuration in the Embodiment 1, will be described. As shown in part (a) of FIG. 3, the coupling portion 301 is provided to the air supplying portion 300. The coupling portion 301 is constituted by a flexible member 320 and the coupling member 310 connected to the flexible member 320. The flexible member 320 is a tube which transports the air from the pump 35 to the receiving opening of the frame of the toner cartridge C. The flexible member 320 is connected to the coupling member 310, and in more detail, one end thereof is connected to the pump 35 and the other end thereof is connected to the coupling member 310. The flexible member 320 is constituted by a flexible tube. Incidentally, the flexible member 320 may have a configuration in which a known tube such as a silicon tube or a urethane tube is used.

The coupling member 310 includes a path through which air passes inside, and is constituted by a portion 311 of which an outer diameter is the same (hereinafter, referred to as a same diameter portion 311) and a portion 312 of which an outer diameter becomes smaller toward a downstream side in a direction X in which air flows (hereinafter, referred to as an inclined portion 312). In this case, with respect to the outer diameter of the same diameter portion 311 of the coupling member 310, the acting portion 221 of the seal portion 220 is configured to be a smaller diameter (the outer diameter of the same diameter portion 311>a diameter (an inner diameter) of the acting portion 221). The same diameter portion 311 is, in the direction X in which the air supplied from the air supplying portion 300 flows, a first portion of which the outer diameter is the same. The inclined portion 312 is a second portion of which the outer diameter becomes smaller from the same diameter portion 311 toward the downstream side in the direction X.

### <Coupling Action and Effect Between the Air Inlet Opening 20 and the Coupling Portion 301>

Next, using FIG. 1 and FIG. 3, a coupling action between the air inlet opening 20 and the coupling portion 301 will be described. As shown in FIG. 1, when the toner cartridge C is inserted toward a direction of an arrow S (the direction X), which is a horizontal direction with respect to the main assembly A, as shown in part (a) of FIG. 3, the air inlet opening 20 of the toner cartridge C approaches the coupling portion 301 of the air supplying portion 300.

At this time, as shown in part (b) of FIG. 3, in a case in which a center 20c of an air path of the air inlet opening 20 and a center 310c of an air path of the coupling member 310 are misaligned in the vertical direction (z direction), for example, the following occurs. That is, with the guide portion 210 provided to the air inlet opening of the toner cartridge C, the inclined portion 312 provided to the coupling member 310 of the coupling portion 301 is brought into contact. As the toner cartridge C is further moved in the direction of the arrow S, since the coupling portion 301 is connected to the flexible member 320, the coupling portion 301 is guided into the air inlet opening 20 with the flexible member 320 being flexed.

Then, the acting portion 221 of the seal portion 220 of the air inlet opening 20, which is shown in part (b) of FIG. 3, is elastically deformed with the supporting portion 223 as a fulcrum. Hereinafter, a portion after the acting portion 221 is elasticity deformed is referred to as an acting portion 222. Here, a position of the acting portion 221 when the coupling member 310 is not connected thereto is defined as a first position. When the coupling member 310 is connected to the air inlet opening 20, the acting portion 221 at the first position is elastically deformed and moved to be the acting portion 222. Here, a position at which the acting portion 221 is elastically deformed and moved to be the acting portion 222 is defined as a second position. The first position is a position of the acting portion 221 of the seal portion 220 in a state in which the frame of the toner cartridge C and the flexible member 320 are not coupled. The position of the acting portion 221 is changed to the second position by the seal portion 220 being elastically deformed in a state in which the frame of the toner cartridge C and the flexible member 320 are coupled, and this is defined as the acting portion 222.

As shown in part (c) of FIG. 3, the acting portion 222 of the seal portion 220 is in contact with the same diameter portion 311 of the coupling member 310. At this time, in a positional relationship between the supporting portion 223 and the acting portion 222 of the seal portion 220, in the direction X in which air flows, it is configured so as the position of the acting portion 222 to be positioned on the downstream side in the direction X of the supporting portion 223. In other words, the second position is, in the direction X in which the air supplied from the air supplying portion 300 flows, positioned on the downstream side of the supporting portion 223. When a side from which the air flows in a direction of the passage of the coupling member 310 is defined as an upstream side, the second position is positioned in a downstream side of the supporting portion 223.

In addition, by the acting portion 222 of the seal portion 220 being in contact with the same diameter portion 311 of the coupling member 310 at a predetermined pressure, air leakage from the coupling portion 301 is prevented. In this case, since the acting portion 222 may be in contact with any portion of the same diameter portion 311 in the direction of the arrow S, it becomes possible to allow a shift (misalignment) in the direction of the arrow S, which is an inserting direction of the toner cartridge C.

By configuring in this manner, it becomes possible to securely couple the air inlet opening 20 and the coupling portion 301, of which positions are determined with respect to each other when the toner cartridge C is mounted. Incidentally, as for an allowable misaligned amount in the vertical direction (z direction) between the center 20c of the air path of the air inlet opening 20 and the center 301c of the air path of the coupling portion 301, it is selectable as appropriately depending on a size of the guide portion 210 and a size of the coupling member 310. In the Embodiment 1, for the allowable misaligned amount in the vertical direction described above, about 4 mm is selected, for example.

In the state shown in part (c) of FIG. 3, the coupling between the air inlet opening 20 of the toner cartridge C and the coupling portion 301 of the air supplying portion 300 is completed. By this, the air discharged from the pump 35 of the air supplying portion 300 passes through an air transport path of the coupling portion 301, and the air is supplied from the air inlet opening 20 of the toner cartridge C to the air chamber 17.

At this time, as an inner pressure of the air chamber 17 is increased, the acting portion 222 of the seal portion 220 is elastically deformed with the supporting portion 223 as a fulcrum to contact closely with the same diameter portion 311 of the coupling member 310. Furthermore, a center aligning action in which the center 310c of the air path of the coupling member 310 is aligned with the center 20c of the air path of the air inlet opening 20 works, it becomes possible to improve sealing performance of the air chamber 17 and maintain the inner pressure of the air chamber 17 with a simple configuration.

As described above, according to the Embodiment 1, it becomes possible to provide a configuration which supplies air from the air supplying means to the toner cartridge.

### Embodiment 2

In the Embodiment 1, a case in which the air inlet opening 20 of the toner cartridge C is constituted by the guide portion 210 and the seal portion 220, and the coupling portion 301 of the air supplying portion 300 is constituted by the coupling member 310 and the flexible member 320 is described. In an Embodiment 2, a case in which an air inlet opening 20A is constituted by a coupling member 310A, and a coupling portion 301A of an air supplying portion 300A is constituted by a guide portion 210A, a seal portion 220A and a flexible member 320A will be described. Configurations of an image forming process and a process cartridge B in the Embodiment 2 are the same as those in the Embodiment 1, and configurations of a main assembly A and a toner cartridge C in the embodiment 2 are the same as those in the Embodiment 1, except for configurations of the air supplying portion 300A and the air inlet opening 20A.

### <Detailed Configuration of the Air Inlet Opening 20A of a Toner Cartridge CA>

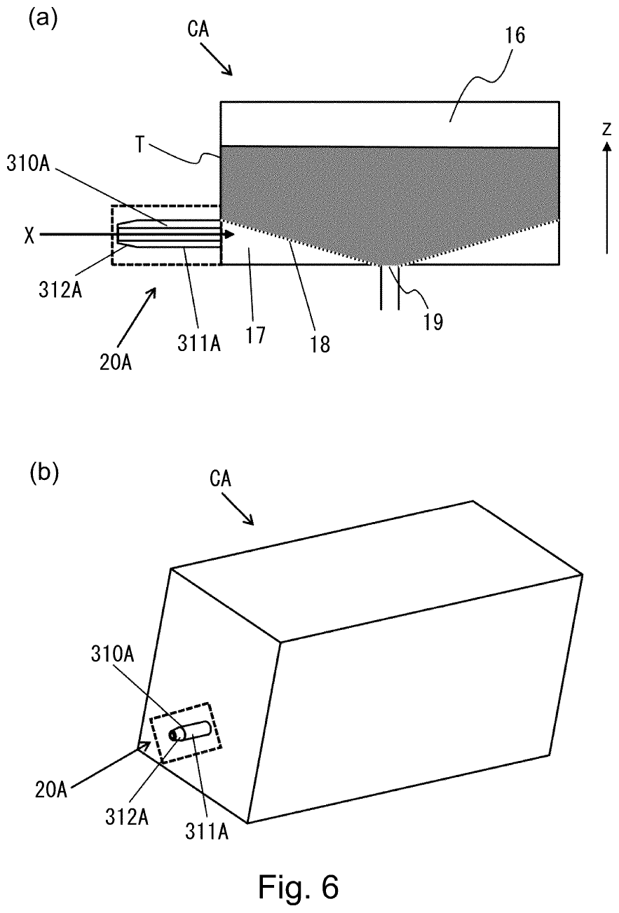

Using FIG. 6, a configuration of the air inlet opening 20A of a toner cartridge CA, which is a characteristic configuration in the Embodiment 2, will be described. Part (a) of FIG. 6 is a cross-sectional view of a structure of the air inlet opening 20A of the toner cartridge CA to which the present invention can be applied, and part (b) of FIG. 6 is a perspective view thereof. As shown in FIG. 6, the air inlet opening 20A provided to the air chamber 17 is constituted by the coupling member 310A, and in the coupling member 310A, a same diameter portion 311A, which is formed in an approximately cylindrical shape, and an inclined portion 312A, which is formed in an approximately conical shape are provided. The same diameter portion 311A as a first portion is, in a direction X in which air supplied from the air supplying portion 300A flows, a portion of which an outer diameter is the same. The inclined portion 312A as a second portion is a portion of which an outer diameter becomes smaller from the same diameter portion 311A toward an upstream side in the direction X. The coupling member 310A includes a path through which the air passes inside, and is constituted by the same diameter portion 311A, of which the outer diameter is the same, and the inclined portion 312A, of which the outer diameter becomes smaller toward the upstream side in the direction X in which the air flows.

### <Detailed Configuration of the Coupling Portion 301A of the Air Supplying Portion 300A>

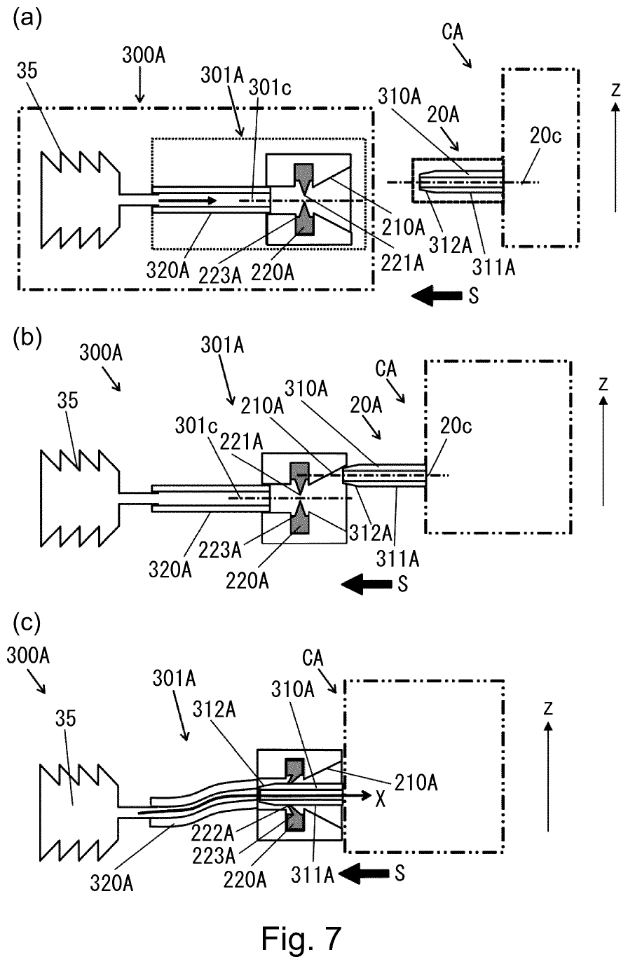

Using FIG. 7, a configuration of the coupling portion 301A of the air supplying portion 300A, which is a characteristic configuration in the Embodiment 2, will be described. FIG. 7 includes cross-sectional views which describe a coupling structure between the air inlet opening 20A and the coupling portion 301A, to which the present invention can be applied. As shown in part (a) of FIG. 7, the coupling portion 301A is provided to the air supply portion 300A, and the coupling portion 301A is constituted by the flexible member 320A, the guide portion 210A and the seal portion 220A connected to the flexible member 320A. In the flexible member 320A, one end thereof is connected to a pump 35 and the other end thereof is connected to an end side on an opposite side to the guide portion 210A across the seal portion 220A. Configurations of the flexible member 320A, the guide portion 210A and the seal portion 220A are the same as those in the Embodiment 1.

### <Coupling Action and Effect Between the Air Inlet Opening 20A and the Coupling Portion 301A>

Next, using FIG. 7, a coupling action between the air inlet opening 20A and the coupling portion 301A will be described. As shown in part (a) of FIG. 7, when the toner cartridge CA is inserted toward a direction of an arrow S, which is a horizontal direction with respect to the main assembly A, the air inlet opening 20A of the toner cartridge CA approaches the coupling portion 301A of the air supplying portion 300A.

At this time, as shown in part (b) of FIG. 7, in a case in which a center 20c of an air path of the air inlet opening 20A and a center 301c of an air path of the coupling member 310A are misaligned in the vertical direction, for example, the following occurs. That is, with the inclined portion 312A provided to the coupling member 310A of the air inlet opening 20A of the toner cartridge CA, the guide portion 210A provided to the coupling portion 301A is brought into contact.

As the toner cartridge CA is further moved in the direction of the arrow S, since the guide portion 210A and the seal portion 220A of the coupling portion 301A are connected to the flexible member 320A, the coupling portion 301A is guided into the air inlet opening 20A with the flexible member 320A being flexed.

As shown in part (b) of FIG. 7, an acting portion 221A (contacting portion, first position) of the seal portion 220A of the coupling portion 301A is elastically deformed with a supporting portion 223A as fulcrum. As shown in part (c) of FIG. 7, an acting portion 222A (contacting portion, second position) of the seal portion 220A is in contact with the same diameter portion 311A of the coupling member 310A. At this time, in a positional relationship between the supporting portion 223A and the acting portion 222A of the seal portion 220A, in the direction X in which the air flows, it is configured so as a position of the acting portion 222A to be positioned on an upstream side of the supporting portion 223A. In this case, since it is possible to maintain a predetermined contact pressure with no matter which portion of the same diameter portion 311A of the coupling member 310A, the acting portion 222A of the seal portion 220A is in contact, as in the Embodiment 1, it becomes possible to allow a shift in the direction of the arrow S, which is the inserting direction of the toner cartridge CA.

By configuring in this manner, as in the Embodiment 1, it becomes possible to securely couple the air inlet opening 20A and the coupling portion 301A, of which positions are determined with respect to each other when the toner cartridge CA is mounted. Incidentally, as for an allowable misaligned amount of the center 20c of the air path of the air inlet opening 20A and the center 301c of the air path of the coupling portion 301A in the vertical direction, it is the same as in the Embodiment 1.

In a state shown in part (c) of FIG. 7, the coupling between the air inlet opening 20A of the toner cartridge CA and the coupling portion 301A of the air supplying portion 300A is completed. By this, the air discharged from the pump 35 of the air supplying portion 300A passes through an air transport path of the coupling portion 301A, and the air is supplied from the air inlet opening 20A of the toner cartridge CA to the air chamber 17. At this time, an action and effect of the seal portion 220A as the inner pressure in the air chamber 17 is increased is the same as in the Embodiment 1.

As described above, according to the Embodiment 2, it becomes possible to provide a configuration which supplies air from the air supplying means to the toner cartridge.

### Embodiment 3

In an Embodiment 3, a case in which an air inlet opening 20B is constituted by a coupling member 310B and a flexible member 320B, and a coupling portion 301B is constituted by a guide portion 210B and a seal portion 220B will be described. Configurations of an image forming process and a process cartridge B in the Embodiment 3 are the same as those in the Embodiment 1, and configurations of a main assembly A and a toner cartridge CB in the Embodiment 3 are the same as those in the Embodiment 1, except for configurations of the air supplying portion 300B and the air inlet opening 20B.

### <Detailed Configuration of the Air Inlet Opening 20B of the Toner Cartridge CB>

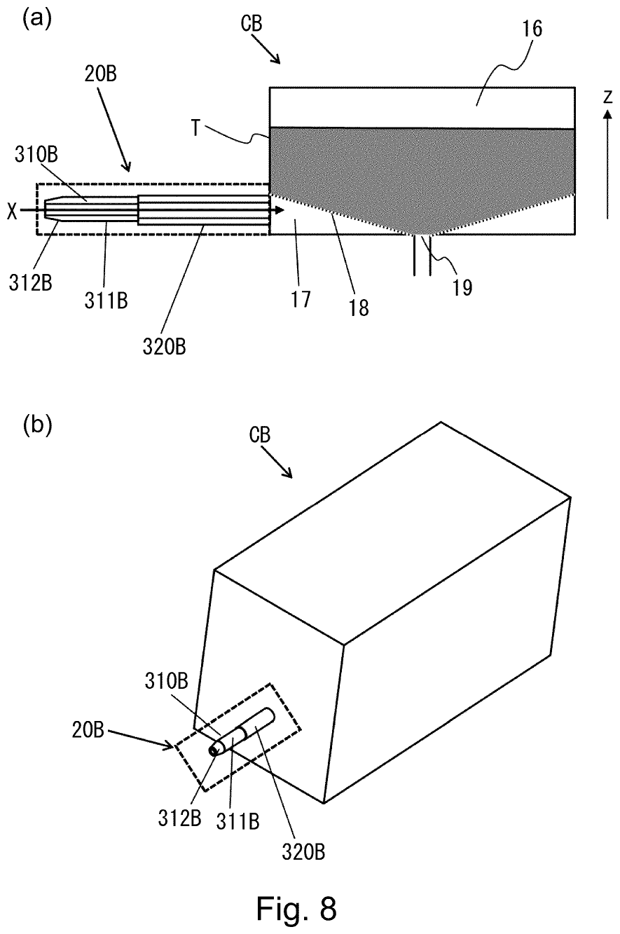

Using FIG. 8, a configuration of the air inlet opening 20B of the toner cartridge CB, which is a characteristic configuration in the Embodiment 3, will be described. Part (a) of FIG. 8 is a cross-sectional view of a structure of the air inlet opening 20B of the toner cartridge CB to which the present invention can be applied, and part (b) of FIG. 8 is a perspective view thereof.

As shown in FIG. 8, the air inlet opening 20B provided to the air chamber 17 is constituted by the flexible member 320B and the coupling member 310B connected to the flexible member 320B. In the coupling member 310B, a same diameter portion 311B (first portion), which is formed in an approximately cylindrical shape, and an inclined portion 312B (second portion), which is formed in an approximately conical shape, are provided. In the flexible member 320B, one end thereof is connected to the same diameter portion 311B of the coupling member 310B, and the other end thereof is connected to an air chamber 17 of the toner cartridge CB.

In addition, a configuration of the flexible member 320B is the same as that in the Embodiment 1, and the flexible member 320B is formed in an approximately cylindrical shape with a path through which air passes inside. The coupling member 310B includes a path through which air passes inside, and is constituted by the same diameter portion 311B, of which an outer diameter is the same, and the inclined portion 312B, of which an outer diameter becomes smaller toward an upstream side in a direction X in which air flows.

### <Detailed Configuration of the Coupling Portion 301B of the Air Supplying Portion 300B>

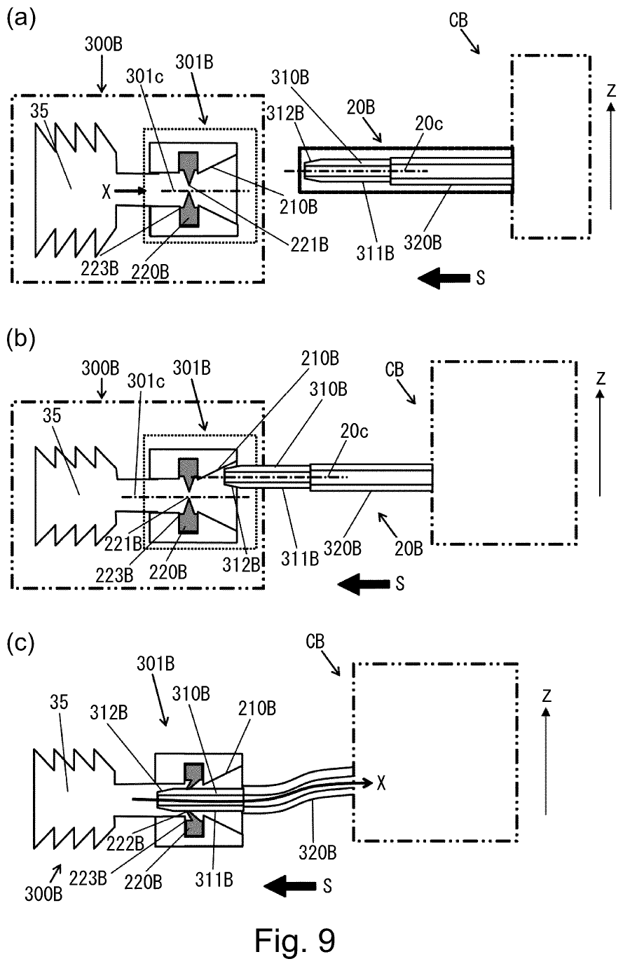

Using FIG. 9, a configuration of the coupling portion 301B of the air supplying portion 300B, which is a characteristic configuration in the Embodiment 3, will be described. FIG. 9 includes cross-sectional views which describe a coupling structure between the air inlet opening 20B and the coupling portion 301B, to which the present invention can be applied. As shown in part (a) of FIG. 9, the coupling portion 301B is provided to the air supplying portion 300B, and the coupling portion 301B is constituted by the guide portion 210B and the seal portion 220B. The configurations of the guide portion 210B and the seal portion 220B are the same as those in the Embodiment 1.

### <Coupling Action and Effect Between the Air Inlet Opening 20B and the Coupling Portion 301B>

Next, using FIG. 9, a coupling action between the air inlet opening 20B and the coupling portion 301B will be described. As shown in part (a) of FIG. 9, when the toner cartridge CB is inserted toward a direction of an arrow S, which is a horizontal direction with respect to the main assembly A, the air inlet opening 20B of the toner cartridge CB approaches the coupling portion 301B of the air supplying portion 300B.

At this moment, as shown in part (b) of FIG. 9, in a case in which a center 20c of an air path of the air inlet opening 20B and a center 301c of an air path of the coupling member 310B are misaligned in the vertical direction, for example, the following occurs. That is, with the inclined portion 312B provided to the coupling member 310B of the air inlet opening 20B of the toner cartridge CB, the guide portion 210B provided to the coupling portion 301B is brought into contact. As the toner cartridge CB is further moved in the direction of the arrow S, since the connecting member 310B of the air inlet opening 20B of the toner cartridge CB is connected to the flexible member 320B, the air inlet opening 20B is guided to the coupling portion 301B with the flexible member 320B being flexed.

As shown in part (b) of FIG. 9, an acting portion 221B (contacting portion, first position) of the seal portion 220B of the coupling portion 301B is elastically deformed with a supporting portion 223B as fulcrum. As shown in part (c) of FIG. 9, an acting portion 222B (contacting portion, second position) of the seal portion 220B is in contact with the same diameter portion 311B of the coupling member 310B. At this time, in a positional relationship between the supporting portion 223B and the acting portion 222B of the seal portion 220B, in a direction X in which air flows, it is configured so as a position of the acting portion 222B to be positioned on an upstream side of the supporting portion 223B.

In this case, since it is possible to maintain a predetermined contact pressure with no matter which portion of the same diameter portion 311B of the coupling member 310B, the acting portion 222B of the seal portion 220B is in contact, as in the Embodiment 1, it becomes possible to allow a shift in the direction of the arrow S, which is the inserting direction of the toner cartridge CB. By configuring in this manner, as in the Embodiment 1, it becomes possible to securely couple the air inlet opening 20B and the coupling portion 301B, of which positions are determined with respect to each other when the toner cartridge CB is mounted. Incidentally, as for an allowable misaligned amount of the center 20c of the air path of the air inlet opening 20B and the center 301c of the air path of the coupling portion 301B in the vertical direction, it is the same as in the Embodiment 1.

In a state shown in part (c) of FIG. 9, the coupling between the air inlet opening 20B of the toner cartridge CB and the coupling portion 301B of the air supplying portion 300B is completed. By this, the air discharged from a pump 35 of the air supplying portion 300B passes through an air transport path of the coupling portion 301B, and the air is supplied from the air inlet opening 20B of the toner cartridge CB to the air chamber 17. In this case, an action and effect of the seal portion 220B as the inner pressure in the air chamber 17 is increased is the same as in the Embodiment 1.

As described above, according to the Embodiment 3, it becomes possible to provide a configuration which supplies air from the air supplying means to the toner cartridge.

### Embodiment 4

In an Embodiment 4, a case in which an air inlet opening 20C is constituted by a guide portion 210C, a seal portion 220C and a flexible member 320C, and a coupling portion 301C is constituted by a coupling member 310C will be described. Configurations of an image forming process and a process cartridge B in the Embodiment 4 are the same as those in the Embodiment 1, and configurations of a main assembly A and a toner cartridge CC in the Embodiment 4 are the same as those in the Embodiment 1, except for configurations of the air supplying portion 300C and the air inlet opening 20C.

### <Detailed Configuration of the Air Inlet Opening 20C of the Toner Cartridge CC>

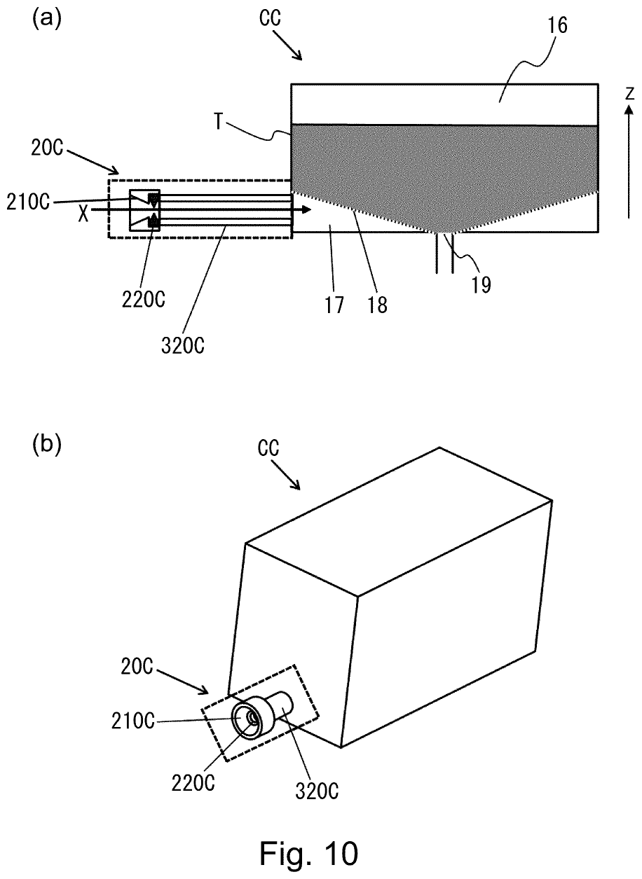

Using FIG. 10, a configuration of the air inlet opening 20C of the toner cartridge CC, which is a characteristic configuration in the Embodiment 4, will be described. Part (a) of FIG. 10 is a cross-sectional view of a structure of the air inlet opening 20C of the toner cartridge CC to which the present invention can be applied, and part (b) of FIG. 10 is a perspective view thereof. As shown in FIG. 10, the air inlet opening 20C provided in the air chamber 17 is constituted by the guide portion 210C, the seal portion 220C and the flexible member 320C. In the flexible member 320C, one end thereof is connected to the seal portion 220C, and the other end is connected to the air chamber 17 of the toner cartridge CC. The flexible member 320C connects the air inlet opening 20C and the air chamber 17. Configurations of the guide portion 210C, the seal portion 220C and the flexible member 320C are the same as those in the Embodiment 1.

### <Detailed Configuration of the Coupling Portion 301C of the Air Supplying Portion 300C>

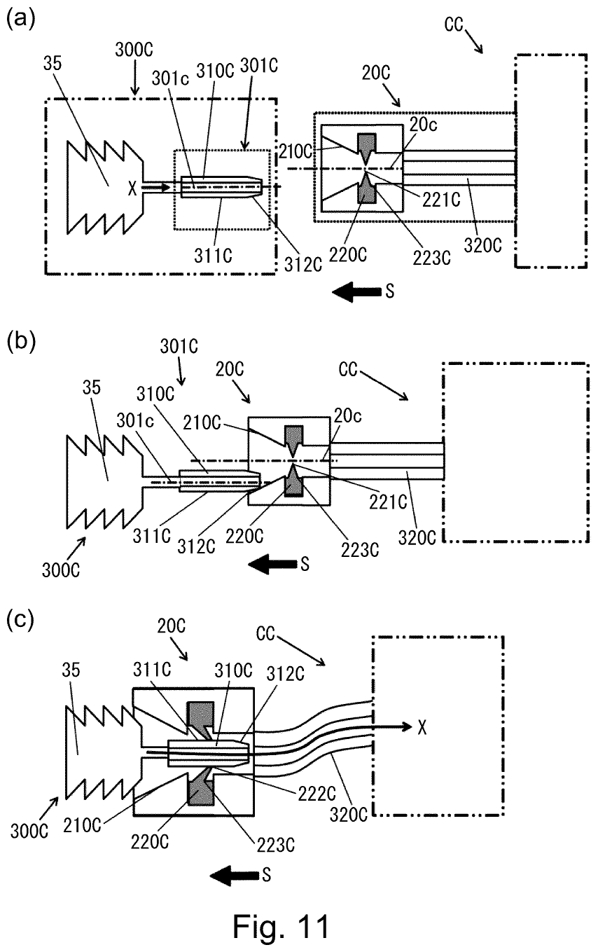

Using FIG. 11, a configuration of the coupling portion 301C of the air supplying portion 300C, which is a characteristic configuration in the Embodiment 4, will be described. FIG. 11 includes cross-sectional views which describe a coupling structure between the air inlet opening 20C and the coupling portion 301C, to which the present invention can be applied. As shown in part (a) of FIG. 11, the coupling portion 301C is provided to the air supplying portion 300C, and the coupling portion 301C is constituted by the coupling member 310C. A configuration of the coupling member 310C is the same as that in the Embodiment 1.

### <Coupling Action and Effect Between the Air Inlet Opening 20C and the Coupling Portion 301C>

Next, using FIG. 11, a coupling action between the air inlet opening 20C and the coupling portion 301C will be described. As shown in part (a) of FIG. 11, when the toner cartridge CC is inserted toward a direction of an arrow S, which is a horizontal direction with respect to the main assembly A, the air inlet opening 20C of the toner cartridge CC approaches the coupling portion 301C of the air supplying portion 300C.

At this time, as shown in part (b) of FIG. 11, in a case in which a center 20c of an air path of the air inlet opening 20C and a center 310c of an air path of the coupling member 310C are misaligned in the vertical direction, for example, the following occurs. That is, with the guide portion 210C provided to the air inlet opening 20C of the toner cartridge CC, an inclined portion 312C provided to the coupling member 310C of the coupling portion 301C is brought into contact. Incidentally, in the inclined portion 312C, an outer diameter thereof becomes smaller from a same diameter portion 311C toward a downstream side in a direction X (part (a) of FIG. 11). As the toner cartridge CC is further moved in the direction of the arrow S, since the guide portion 210C and the seal portion 220C are connected to the flexible member 320C, the air inlet opening 20C is guided into the coupling portion 301C with the flexible member 320C being flexed.

As shown in part (c) of FIG. 11, an acting portion 221C (contacting portion, first position) of the seal portion 220C of the air inlet opening 20C is elastically deformed with a supporting portion 223C as fulcrum. An acting portion 222C (contacting portion, second position) of the seal portion 220C is in contact with the same diameter portion 311C (a first portion) of the coupling member 310C. At this time, in a positional relationship between the supporting portion 223C and the acting portion 222C of the seal portion 220C, in the direction X in which the air flows, it is configured so as a position of the acting portion 222C to be positioned on a downstream side of the supporting portion 223C.

In this case, since it is possible to maintain a predetermined contact pressure with no matter which portion of the same diameter portion 311C of the coupling member 310C, the acting portion 222C of the seal portion 220C is in contact, as in the Embodiment 1, it becomes possible to allow a shift in the direction of the arrow S, which is an inserting direction of the toner cartridge CC. By configuring in this manner, as in the Embodiment 1, it becomes possible to securely couple the air inlet opening 20C and the coupling portion 301C, of which positions are determined with respect to each other when the toner cartridge CC is mounted. Incidentally, as for an allowable misaligned amount of the center 20c of the air path of the air inlet opening 20C and the center 301c of the air path of the coupling portion 301C in the vertical direction, it is the same as in the Embodiment 1.

In a state shown in part (c) of FIG. 11, the coupling between the air inlet opening 20C of the toner cartridge CC and the coupling portion 301C of the air supplying portion 300C is completed. By this, the air discharged from a pump 35 of the air supplying portion 300C passes through an air transport path of the coupling portion 301C, and the air is supplied from the air inlet opening 20C of the toner cartridge CC to the air chamber 17. In this case, an action and effect of the seal portion 220C as an inner pressure in the air chamber 17 is increased is the same as in the Embodiment 1.

As described above, according to the Embodiment 4, it becomes possible to provide a configuration which supplies air from the air supplying means to the toner cartridge.

### Embodiment 5

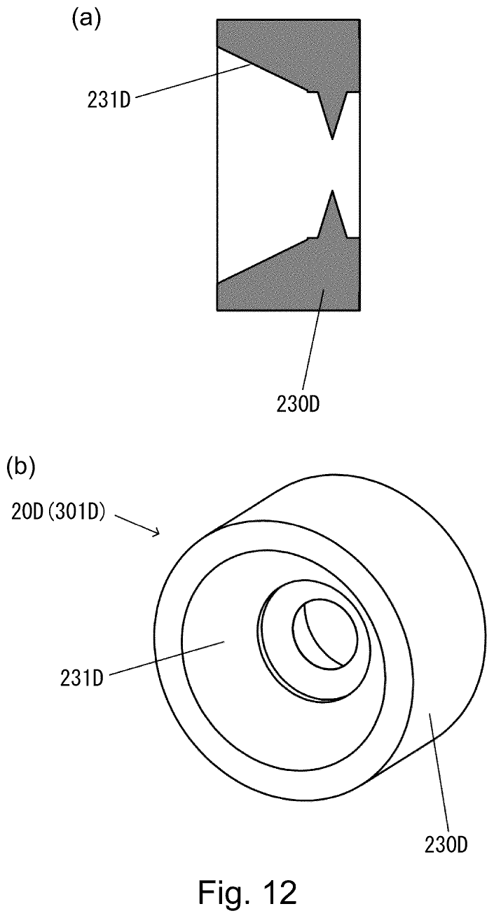

Next, a configuration in an Embodiment 5 in the present invention will be described using FIG. 12. Part (a) of FIG. 12 is a cross-sectional view describing a seal portion 230D, to which the present invention can be applied, and part (b) of FIG. 12 is a perspective view thereof. In the Embodiments described above, the cases in which the guide portion 210 (210A through 210C) and the seal portion 220 (220A through 220C) are structured as separate parts are described, however, it is not limited thereto. As shown in FIG. 12, even a configuration in which a guide portion 231D and the seal portion 230D are integrally provided can be suitably used. The seal portion 230D and the guide portion 231D, which are integrally structured, may be used as an air inlet opening 20D or as a coupling portion 301D.

As described above, according to the Embodiment 5, it becomes possible to provide a configuration which supplies air from the air supplying means to the toner cartridge.

### Embodiment 6

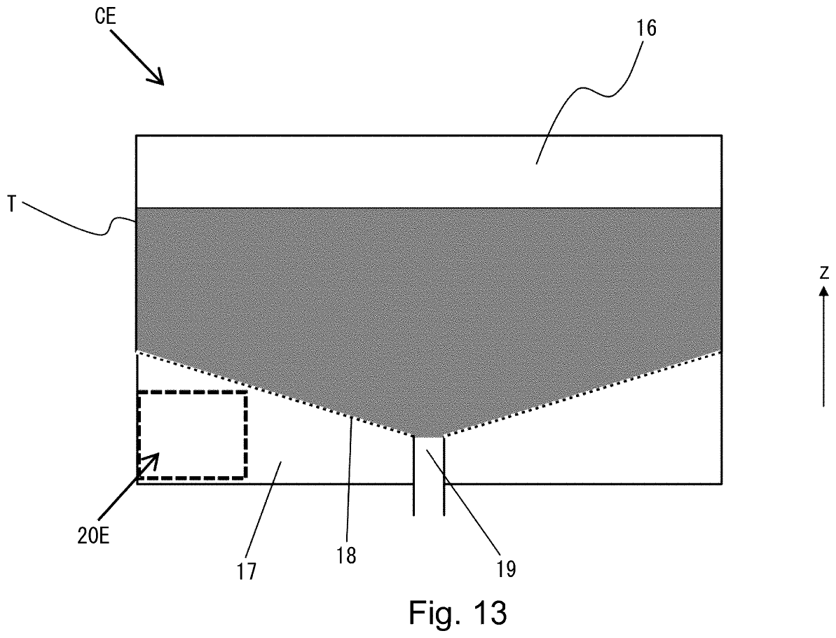

Next, a configuration in an Embodiment 6 in the present invention will be described using FIG. 13. FIG. 13 is a cross-sectional view describing a toner cartridge CE to which the present invention can be applied. In the Embodiments described above, the configurations in which the air inlet opening 20 (20A through 20D) are disposed outside the air chamber 17 are described, however, it is not limited thereto.

For example, as shown in FIG. 13, a ventilation member 18 is disposed below a toner accommodating portion 16 in a vertical direction, and an air inlet opening 20E is disposed below the ventilation member 18 in the vertical direction and inside the air chamber 17. In this manner, even a configuration in which the ventilation member 18 is disposed below the toner accommodating portion 16 of the toner cartridge CE and the air inlet opening 20E is disposed below the ventilation member 18 can be suitably used. As described above, by disposing the air inlet opening 20E below the ventilation member 18, it becomes possible to structure the toner cartridge CE in a space-saving manner.

As described above, according to the Embodiment 6, it becomes possible to provide a configuration which supplies air from the air supplying means to the toner cartridge.

### Embodiment 7

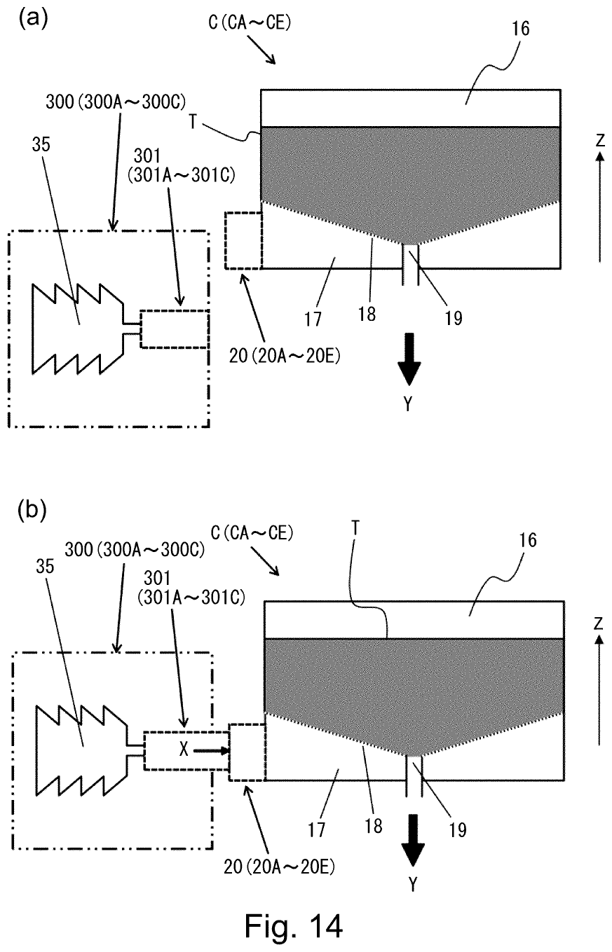

FIG. 14 includes cross-sectional views describing mounting of the toner cartridge C (CA through CE), to which the present invention can be applied, to the main assembly A. Incidentally, as the toner cartridge C (CA through CE) in FIG. 14, an example in which the air inlet opening 20 (20A through 20E) are provided outside the air chamber 17 is illustrated, however, as in the Embodiment 6, it is also applicable to the configuration in which the air inlet opening 20 is provided inside the air chamber 17. In the Embodiments described above, the cases in which the toner cartridge C (CA through CE) is inserted in the horizontal direction(S) into the main assembly A are described, however, it is not limited thereto. For example, as shown in FIG. 14, it can be suitably used even for a case in which the toner cartridge C (CA through CE) is mounted to the main assembly A in a vertical direction Y (−z direction) (a direction approximately perpendicular to the direction X).

As shown in part (a) of FIG. 14, upon mounting the toner cartridge C (CA through CE) to the main assembly A in the vertical direction Y, the coupling portion 301 (301A through 301C) of the air supplying portion 300 (300A through 300C) is in the following state. That is, the coupling portion 301 (301A through 301C) of the air supplying portion 300 (300A through 300C) are retracted in a position at which the coupling portion 301 does not interfere with the air inlet opening 20 (20A through 20E) of the toner cartridge C (CA through CE) in the horizontal direction.

As shown in part (b) of FIG. 14, when a move of the toner cartridge C (CA through CE) to the main assembly A in the vertical direction Y is completed, the coupling portion 301 (301A through 301C) of the air supplying portion 300 (300A through 300C) is in the following state. That is, the coupling portion 301 (301A through 301C) of the air supplying portion 300 (300A through 300C) is extended in the horizontal direction by a known extending means (not shown), and is coupled to the air inlet opening 20 (20A through 20E) of the toner cartridge C (CA through CE). With the configuration described above, it becomes possible to mount the toner cartridge C (CA through CE) to the main assembly A in the vertical direction Y.

As described above, according to the Embodiment 7, it becomes possible to provide a configuration which supplies air from the air supplying means to the toner cartridge.

### Embodiment 8

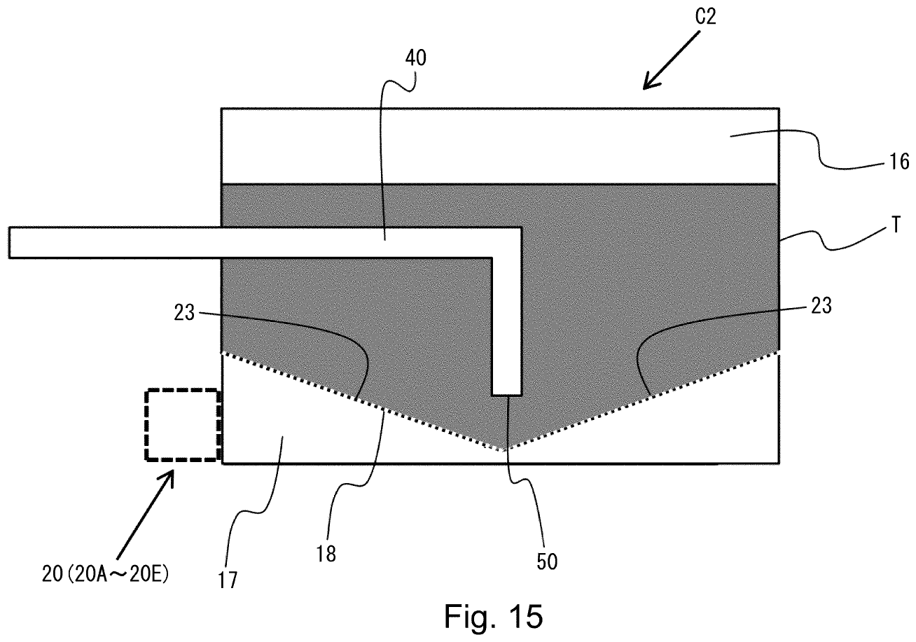

Next, a configuration of an Embodiment 8 in the present invention will be described using FIG. 15. FIG. 15 is an explanatory view of a toner cartridge C2. Incidentally, as the toner cartridge C2 in FIG. 15, an example in which the air inlet opening 20 (20A through 20E) is provided outside the air chamber 17 is illustrated, however, as in the Embodiment 6, it is also applicable to the configuration in which the air inlet opening is provided inside the air chamber 17. The configuration in the Embodiment 8 is different from the Embodiments described above in configurations of a transport path and a discharging opening. The toner cartridge C2 in the Embodiment 8 is provided with a toner accommodating portion 16, an air chamber 17, a ventilation member 18, a discharging opening 50, an air inlet opening 20 (20A through 20E) and a transport path 40.

The transport path 40 is a path which connects the discharging opening 50 and an outside of the toner cartridge C2. The ventilation member 18 includes an inclined portion 23 below toward the discharging opening 50, the inclined portion 23 forms a bottom surface of the toner accommodating portion 16, and the discharging opening 50 is positioned at a position higher than a lowest surface of the ventilation member 18 in a vertical direction. Even for the configuration of the transport path 40 and the discharging opening 50 as described in the toner cartridge C2, as in the Embodiments described above, the present invention can also be suitably used.

As described above, according to the Embodiment 8, it becomes possible to provide a configuration which supplies air from the air supplying means to the toner cartridge.

### Embodiment 9

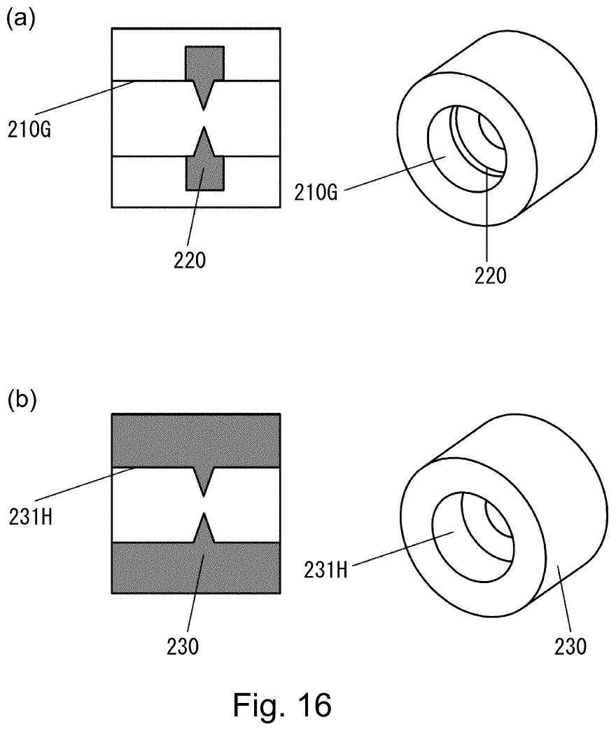

Next, a configuration in an Embodiment 9 in the present invention will be described using FIG. 16. FIG. 16 includes cross-sectional views and perspective views describing guide portions 210G and 231H to which the present invention can be applied. In the Embodiments described above, the cases in which the guide portion 210 (210A through 210C, 231D) is structured by the inclined surface are described, however, it is not limited thereto.

For example, as shown in part (a) of FIG. 16, in a guide portion 210G in the Embodiment 9, an inner diameter thereof is constant toward the coupling member 310. As such, even for a case in which the guide portion 210G is structured by a surface which is not inclined, as in the Embodiments described above, the present invention can be suitably used. In addition, as shown in part (b) of FIG. 16, even for a case in which a guide portion 231H and a seal portion 230H are integrally provided, and the guide portion 231H is structured by a surface which is not inclined, as in the Embodiments described above, the present invention can be suitably used.

As described above, according to the Embodiment 9, it becomes possible to provide a configuration which supplies air from the air supplying means to the toner cartridge.

Disclosure of the present Embodiments includes the following constitutions.

### (Constitution 1)

A toner cartridge comprising:
a frame configured to form a space inside thereof;
a ventilation member fixed to the frame and configured to partition the space into an accommodating chamber for accommodating toner and an air chamber including a receiving opening for receiving air, the ventilation member restricting passing of the toner and allowing passing of the air;
a pump configured to discharge the air to be supplied to the air chamber;
a tube configured to transport the air from the pump to the receiving opening of the frame;
a cylindrical coupling member including a passage for communicating the air between the frame and the tube, the coupling member being configured to couple the frame and the tube; and
an annular seal portion configured to seal a gap between an outer peripheral surface of the coupling member and the frame,
wherein the seal portion includes a contacting portion configured to be contactable with the outer peripheral surface of the coupling member on an inner peripheral side thereof and a supporting portion supporting the contacting portion on an outer peripheral side thereof,
wherein when a position of the contacting portion of the seal portion is defined as a first position in a state in which the frame and the tube are not coupled, the position of the contacting portion is changed to a second position by the seal portion being elastically deformed in a state in which the frame and the tube are coupled, and
wherein when a side from which the air flows in a direction of the passage of the coupling member is defined as an upstream side, the second position is positioned in a downstream side of the supporting portion.

### (Constitution 2)

A toner cartridge comprising:
a frame configured to form a space inside thereof;
a ventilation member fixed to the frame and configured to partition the space into an accommodating chamber for accommodating toner and an air chamber including a receiving opening for receiving air, the ventilation member restricting passing of the toner and allowing passing of the air;
a pump configured to discharge the air to be supplied to the air chamber;
a tube configured to transport the air from the pump to the receiving opening of the frame;
a cylindrical coupling member including a passage for communicating the toner between the frame and the pump, the coupling member being configured to couple the frame and the tube; and
an annular seal member configured to seal a gap between an outer peripheral surface of the coupling member and the frame,
wherein when a side from which the air flows in a direction of the passage of the coupling member is defined as an upstream side, the coupling member includes a first portion of which an outer diameter is the same and a second portion of which an outer diameter becomes smaller from the first portion toward the upstream side.

### (Constitution 3)

The toner cartridge according Constitution 1 or Constitution 2, further comprising a guide portion integrally formed with the seal portion.

### (Constitution 4)

The toner cartridge according to Constitution 3, wherein the guide portion increases in an inner diameter toward the coupling member.

### (Constitution 5)

The toner cartridge according to Constitution 3, wherein the guide portion is constant in an inner diameter toward the coupling member.

### (Constitution 6)

The toner cartridge according to any one of Constitution 1 to Constitution 5, wherein the ventilation member is disposed below the accommodating chamber in a vertical direction, and
wherein the receiving opening is disposed below the ventilation member in the vertical direction and inside the air chamber.

### (Constitution 7)

The toner cartridge according to any one of Constitution 1 to Constitution 5, wherein the ventilation member is disposed below the accommodating chamber in a vertical direction, and
wherein the receiving opening is disposed outside the air chamber.

### (Constitution 8)

An image forming apparatus comprising:
a main assembly of the image forming apparatus configured to detachably support a toner cartridge,
wherein the toner cartridge including:
   a frame configured to form a space inside thereof;
   a ventilation member fixed to the frame and configured to partition the space into an accommodating chamber for accommodating toner and an air chamber including a receiving opening for receiving air, the ventilation member restricting passing of the toner and allowing passing of the air;
   a pump configured to discharge the air to be supplied to the air chamber;
   a tube configured to transport the air from the pump to the receiving opening of the frame;
   a cylindrical coupling member including a passage for communicating the air between the frame and the tube, the coupling member being configured to couple the frame and the tube; and
   an annular seal portion configured to seal a gap between an outer peripheral surface of the coupling member and the frame,
wherein the seal portion includes a contacting portion configured to be contactable with the outer peripheral surface of the coupling member on an inner peripheral side thereof and a supporting portion supporting the contacting portion on an outer peripheral side thereof,
wherein when a position of the contacting portion of the seal portion is defined as a first position in a state in which the frame and the tube are not coupled, the position of the contacting portion is changed to a second position by the seal portion being elastically deformed in a state in which the frame and the tube are coupled,
wherein when a side from which the air flows in a direction of the passage of the coupling member is defined as an upstream side, the second position is positioned in a downstream side of the supporting portion,
wherein the coupling member includes a first portion of which an outer diameter is the same and a second portion of which an outer diameter becomes smaller from the first portion toward the upstream side. and wherein the toner cartridge is supplied with the air by the pump while the coupling member is coupled with the receiving opening.

### (Constitution 9)

An image forming apparatus comprising:
a main assembly of the image forming apparatus configured to detachably support a toner cartridge,
wherein the toner cartridge including:
   a frame configured to form a space inside thereof;
   a ventilation member fixed to the frame and configured to partition the space into an accommodating chamber for accommodating toner and an air chamber including a receiving opening for receiving air, the ventilation member restricting passing of the toner and allowing passing of the air;
   a pump configured to discharge the air to be supplied to the air chamber;
   a tube configured to transport the air from the pump to the receiving opening of the frame;
   a cylindrical coupling member including a passage for communicating the air between the frame and the tube, the coupling member being configured to couple the frame and the tube; and
   an annular seal portion configured to seal a gap between an outer peripheral surface of the coupling member and the frame,
wherein when a side from which the air flows in a direction of the passage of the coupling member is defined as an upstream side, the coupling member includes a first portion of which an outer diameter is the same and a second portion of which an outer diameter becomes smaller from the first portion toward the upstream side.
wherein the seal portion includes a contacting portion configured to be contactable with the outer peripheral surface of the coupling member on an inner peripheral side thereof and a supporting portion supporting the contacting portion on an outer peripheral side thereof,
wherein when a position of the contacting portion of the seal portion is defined as a first position in a state in which the frame and the tube are not coupled, the position of the contacting portion is changed to a second position by the seal portion being elastically deformed in a state in which the frame and the tube are coupled,
wherein when a side from which the air flows in a direction of the passage of the coupling member is defined as an upstream side, the second position is positioned in a upstream side of the supporting portion, and
wherein the toner cartridge is supplied with the air by the pump while the coupling member is coupled with the receiving opening.

### (Constitution 10)

The image forming apparatus according to Constitution 8 or Constitution 9, further comprising a guide portion integrally formed with the seal portion.

### (Constitution 11)

The image forming apparatus according to Constitution 10, wherein the guide portion increases in an inner diameter toward the coupling member.

### (Constitution 12)

The image forming apparatus according to Constitution 10, wherein the guide portion is constant in an inner diameter toward the coupling member.

### (Constitution 13)

The image forming apparatus according to any one of Constitution 8 to Constitution 12, wherein the ventilation member is disposed below the accommodating chamber in a vertical direction, and
wherein the receiving opening is disposed below the ventilation member in the vertical direction and inside the air chamber.

### (Constitution 14)

The image forming apparatus according to any one of Constitution 8 to Constitution 12, wherein the ventilation member is disposed below the accommodating chamber in a vertical direction, and
wherein the receiving opening is disposed outside the air chamber.

### (Constitution 15)

The image forming apparatus according to any one of Constitution 8 to Constitution 14, wherein the toner cartridge is mounted and demounted in a direction substantially perpendicular to a direction of the passage of the coupling member.

### (Constitution 16)

The image forming apparatus according to any one of Constitution 8 to Constitution 14, wherein the toner cartridge is mounted and demounted in a direction of the passage of the coupling member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-158650 filed on Sep. 12, 2024, which is hereby incorporated by reference herein in its entirety.

What is claimed is:

1. A toner cartridge comprising:
a frame configured to form a space inside thereof;
a ventilation member fixed to the frame and configured to partition the space into an accommodating chamber for accommodating toner and an air chamber including a receiving opening for receiving air, the ventilation member restricting passing of the toner and allowing passing of the air;
a pump configured to discharge the air to be supplied to the air chamber;
a tube configured to transport the air from the pump to the receiving opening of the frame;
a cylindrical coupling member including a passage for communicating the air between the frame and the tube, the coupling member being configured to couple the frame and the tube; and
an annular seal portion configured to seal a gap between an outer peripheral surface of the coupling member and the frame,
wherein the seal portion includes a contacting portion configured to be contactable with the outer peripheral surface of the coupling member on an inner peripheral side thereof and a supporting portion supporting the contacting portion on an outer peripheral side thereof,
wherein when a position of the contacting portion of the seal portion is defined as a first position in a state in which the frame and the tube are not coupled, the position of the contacting portion is changed to a second position by the seal portion being elastically deformed in a state in which the frame and the tube are coupled, and
wherein when a side from which the air flows in a direction of the passage of the coupling member is defined as an upstream side, the second position is positioned on a downstream side of the supporting portion.

2. A toner cartridge comprising:
a frame configured to form a space inside thereof;
a ventilation member fixed to the frame and configured to partition the space into an accommodating chamber for accommodating toner and an air chamber including a receiving opening for receiving air, the ventilation member restricting passing of the toner and allowing passing of the air;
a pump configured to discharge the air to be supplied to the air chamber;
a tube configured to transport the air from the pump to the receiving opening of the frame;
a cylindrical coupling member including a passage for communicating the air between the frame and the pump, the coupling member being configured to couple the frame and the tube; and
an annular seal member configured to seal a gap between an outer peripheral surface of the coupling member and the frame,
wherein when a side from which the air flows in a direction of the passage of the coupling member is defined as an upstream side, the coupling member includes a first portion of which an outer diameter is the same and a second portion of which an outer diameter becomes smaller from the first portion toward the upstream side.

3. The toner cartridge according to claim 1, further comprising a guide portion integrally formed with the seal portion.

4. The toner cartridge according to claim 3, wherein the guide portion increases in an inner diameter toward the coupling member.

5. The toner cartridge according to claim 3, wherein the guide portion is constant in an inner diameter thereof toward the coupling member.

6. The toner cartridge according to claim 1, wherein the ventilation member is disposed below the accommodating chamber in a vertical direction, and
wherein the receiving opening is disposed below the ventilation member in the vertical direction and inside the air chamber.

7. The toner cartridge according to claim 1, wherein the ventilation member is disposed below the accommodating chamber in a vertical direction, and
wherein the receiving opening is disposed outside the air chamber.

8. An image forming apparatus comprising:
a main assembly of the image forming apparatus configured to detachably support a toner cartridge,
wherein the toner cartridge including:
a frame configured to form a space inside thereof;
a ventilation member fixed to the frame and configured to partition the space into an accommodating chamber for accommodating toner and an air chamber including a receiving opening for receiving air, the ventilation member restricting passing of the toner and allowing passing of the air;
a pump configured to discharge the air to be supplied to the air chamber;
a tube configured to transport the air from the pump to the receiving opening of the frame;
a cylindrical coupling member including a passage for communicating the air between the frame and the tube, the coupling member being configured to couple the frame and the tube; and
an annular seal portion configured to seal a gap between an outer peripheral surface of the coupling member and the frame,
wherein the seal portion includes a contacting portion configured to be contactable with the outer peripheral surface of the coupling member on an inner peripheral side thereof and a supporting portion supporting the contacting portion on an outer peripheral side thereof,
wherein when a position of the contacting portion of the seal portion is defined as a first position in a state in which the frame and the tube are not coupled, the position of the contacting portion is changed to a second position by the seal portion being elastically deformed in a state in which the frame and the tube are coupled,
wherein when a side from which the air flows in a direction of the passage of the coupling member is defined as an upstream side, the second position is positioned in a downstream side of the supporting portion,
wherein the coupling member includes a first portion of which an outer diameter is the same and a second portion of which an outer diameter becomes smaller from the first portion toward the upstream side. and
wherein the toner cartridge is supplied with the air by the pump while the coupling member is coupled with the receiving opening.

9. The image forming apparatus according to claim 8, further comprising a guide portion integrally formed with the seal portion.

10. The image forming apparatus according to claim 8, wherein the guide portion increases in an inner diameter toward the coupling member.

11. The image forming apparatus according to claim 8, wherein the guide portion is constant in an inner diameter toward the coupling member.

12. The image forming apparatus according to claim 8, wherein the ventilation member is disposed below the accommodating chamber in a vertical direction, and
wherein the receiving opening is disposed below the ventilation member in the vertical direction and inside the air chamber.

13. The image forming apparatus according to claim 8, wherein the ventilation member is disposed below the accommodating chamber in a vertical direction, and
wherein the receiving opening is disposed outside the air chamber.

14. The image forming apparatus according to claim 8, wherein the toner cartridge is mounted and demounted in a direction substantially perpendicular to a direction of the passage of the coupling member.

15. The image forming apparatus according to claim 8, wherein the toner cartridge is mounted and demounted in a direction of the passage of the coupling member.
